(19) United States
(12) Patent Application Publication
(10) Pub. No.: US 2002/0110660 A1
(43) Pub. Date: Aug. 15, 2002

(54) Sticker structure exclusive for a sticker machine

(76) Inventor: Teng-Tsung Yeh, Tu-Cheng City (TW)

Correspondence Address: Teng-Tsung Yeh, P.O. Box No. 6-57, Chung-Ho City, 235, TW

(21) Appl. No.: 09/783,310

(22) Filed: Feb. 15, 2001

(51) Int. Cl. B32B 9/00

(52) U.S. Cl. 428/42.3

(57) ABSTRACT

The invention herein of a sticker structure exclusive for a sticker machine is to provide a sticker layer requiring no manual peeling but capable of completely riding the conventional sticker's shortcoming of being easily misplaced. The sticker mainly comprises of oilpaper, the sticker layers and the adhesive layer, wherein the upper surface of oilpaper has glossy and oily layer; the sticker layers are positioned and equally spaced apart on the lower surface of oilpaper, with patterns printed on the bottom side and a glossy side glued onto oilpaper by adhesive points or layers of lower viscosity; the adhesive layer is evenly coated on the bottom side of the sticker layers with the viscosity higher than that of the adhesive points or layers; the stickers are dispensed one after the other through the sticker machine; as the sticker layer is pointed at the predetermined location, it will be pressed to separate from the adhesive point or layer on the top side and precisely be adhered to the predetermined position.

### BACKGROUND OF THE INVENTION

1. Field of the Invention

The invention herein relates to a sticker structure exclusive for the sticker machine, more especially a sticker structure adaptable for a sticker machine to precisely stick the stickers to the predetermined position and benefit the adhering operation of the stickers.

2. Description of the Prior Art

The conventional stickers with cartoon patterns sold widely in the markets mainly use oilpaper in proper sizes with several illustrated or patterned stickers spaced apart thereon and an adhesive layer with viscosity coated between the bottom side of the stickers and the attached oilpaper.

For using the sticker mentioned above, the user only has to peel off the sticker from oilpaper to stick to the desired location; when peeling off the sticker from oilpaper, since the adhesive layer on the bottom side of the sticker will not be fixed to the glossy and oily layer, the user can easily peel off the sticker and stick it to the predetermined location by the adhesive layer.

Although the conventional sticker can achieve the effect of adhesion, the adhesive layer on the lower side, while the stickers still on oilpaper, cannot fix the sticker thereon; therefore, when not in use, the sticker will easily fall off oilpaper or curl up due to improper storage; furthermore, the sticker fell off or curled up will cling to the dust and become unusable or be misplaced.

Furthermore, since the conventional stickers need to be removed manually from oilpaper, the user's hand will touch the adhesive layer on the bottom side during peeling, therefore, the adhesive layer touched by the hand may be easily split from the sticker and stuck to the hand so as to not only fail in being precisely placed to the desired location, but also make the sticky hand hard to be cleaned due to the too high viscosity of the adhesive layer, therefore, this kind of sticker paper structure really needs to be improved.

In view of the foregoing reasons, the inventor of the invention herein, based on the practical experience of research, development, manufacturing and selling of the related products, determined to invent a sticker structure exclusively adaptable for the sticker machine, capable of increasing the convenience and making the transferring and adhering operation more precisely; after continuous research and improvement, finally and successfully designed a sticker structure exclusive for the sticker machine to enable fast and precise sticker placing process and ensure the integrity of the sticker while not in use.

### SUMMARY OF THE INVENTION

Specifically, the sticker of the invention herein mainly comprises of oilpaper, sticker layer and adhesive layer, wherein the upper surface of the oilpaper has glossy and oily layer; the sticker layers are positioned and equally spaced apart on the lower surface of oilpaper, with patterns printed on the bottom side and a glossy side glued onto oilpaper by adhesive points or layers of lower viscosity; the adhesive layer is evenly coated on the bottom side of the sticker layers with the viscosity higher than that of the adhesive points or layers; when in use, the stickers are dispensed one after the other through the sticker machine; as the sticker layer is pointed at the predetermined location, it will be pressed to separate from the adhesive point or layer on the top side and precisely adhered to the predetermined position.

The primary objective of the invention herein is to precisely position the sticker layer on the bottom side of oilpaper by the adhesive point or layer mentioned above to increase the precision of placing the sticker layer on oilpaper.

Another objective of the invention herein is to mount a layer of translucent film on the bottom side of the adhesive layer during manufacturing to increase the precision of placing the sticker layer on oilpaper and specifically rid the possible situation of having dust clung to the adhesive layer.

To enable a further understanding of the structural features, the effect and the purposes of the invention herein, the brief description of the drawings below is followed by the detailed description of the preferred embodiments.

### BRIEF DESCRIPTION OF THE DRAWINGS

FIG. 1 is an isometric drawing of the structure of the invention herein.

FIG. 2 is an enlarged drawing of Part A of FIG. 1.

FIG. 3 is an isometric drawing of another preferred embodiment of the invention herein.

FIG. 4 is an enlarged drawing of Part B of FIG. 3.

### DETAILED DESCRIPTION OF PREFERRED EMBODIMENTS

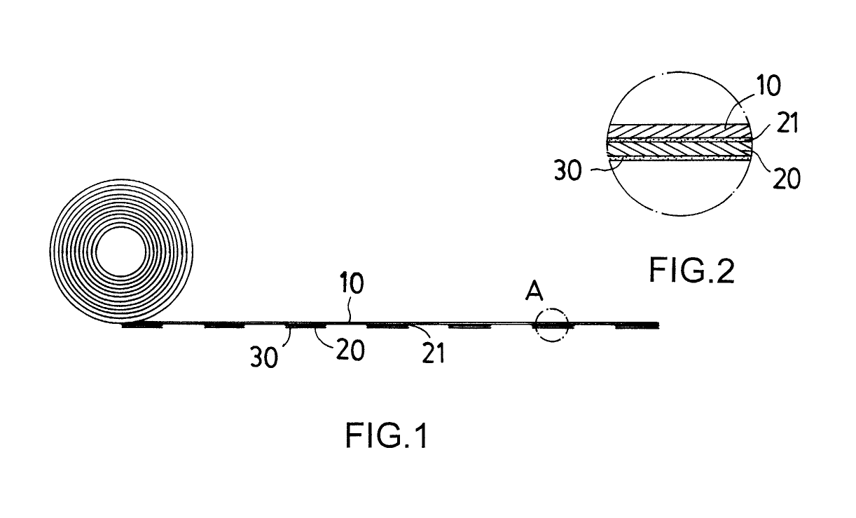

Referring to FIGS. 1 & 2 of the isometric drawings of the sticker structure of the invention herein, as shown the invention herein mainly comprises of oilpaper (10), the sticker layers (20) and the adhesive layer (30), wherein:

A glossy and oily layer is on the upper surface of oilpaper (10); the sticker layers (20) are placed and equally spaced apart on the lower surface of oilpaper (10), with pictures in mono-pattern or in diverse patterns printed on the bottom side, and a glossy side glued onto oilpaper (10) by adhesive points or layers of lower viscosity; the adhesive layer (30) is evenly coated on the bottom side of the sticker layers (20) with viscosity higher than that of the adhesive points or layers mainly for adhering to the predetermined positions.

The sticker mentioned above is in a roll configuration; when being rolled in, the sticker layers (20) located on the internal ring is adjacent to oilpaper (10) on the external ring; since the stickers are placed in an enclosed sticker machine (not showing in the drawings), when in use, the stickers are dispensed one after the other from the sticker machine; therefore, situations of the stickers being misplaced or becoming unusable due to being clung to the dust will not happen.

Furthermore, since the sticker is mainly adaptable for the use of the sticker machine, in order to be stuck at a predetermined position, the sticker layer (20) will be pressed properly to fall off the adhesive point or layer (21) on the top side, so the user does not need to manually peel off the sticker layer (20); therefore, the shortcomings of manual access and adhesion of the sticker will be completely ridded to achieve the effect of precisely placing and adhering the sticker layer (20).

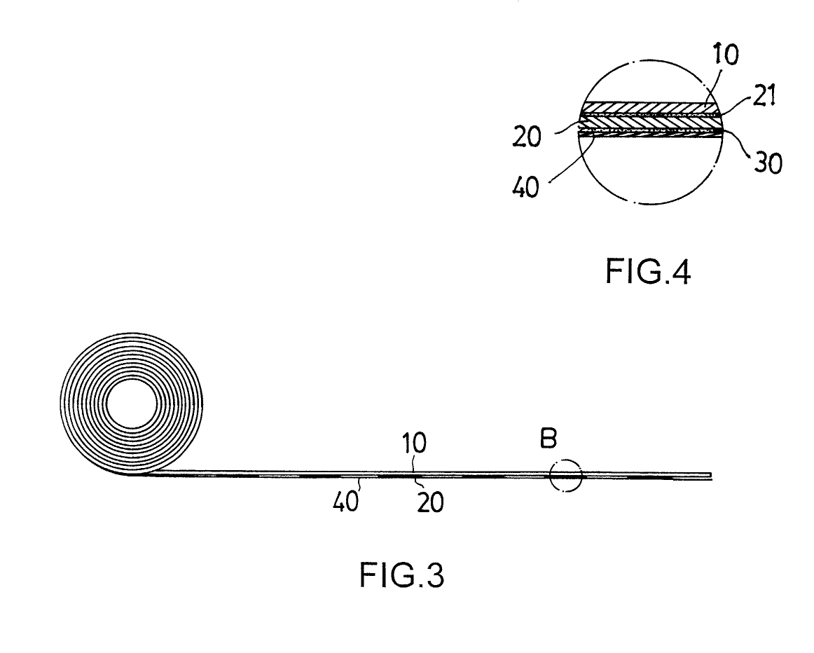

Referring to FIG. 3 & 4 of the structural isometric drawings of another preferred embodiment, while the sticker is being manufactured, a layer of translucent film (40) can be mounted beneath the adhesive layer (30); when in use, the translucent film (40) moves in reverse direction to separate from the sticker layer (20) to be adhered; the translucent film (40) not only increases the precision of positioning the sticker layer (20) on oilpaper (10), but also ensure the ridding of having adhesive layer (30) clung to the dust.

In summation of the description from FIG. 1 to FIG. 4, the sticker, capable of achieving the effect of precise adhesion by means of the adhesive point of layer (21) on oilpaper (10) and the use of the adhesive layer (30) coated on the bottom side of the sticker layer (20), fully complying with the patent application requirement of being industrial usable, innovative and progressive, is hereby submitted to the patent bureau for review and the granting of the commensurate patent for ensuring the inventor's right.

The foregoing names used for all the members and illustrations are for the convenient description of the structure of the invention herein but not for restricting the patent field of the invention herein; therefore, any modified or substitute members with equivalent effect based on the innovative spirit, the space and the style of the invention herein should be included within the protected patent scope of the invention herein.

1. A sticker structure exclusive for the sticker machine consists of
Oilpaper with glossy and oily layer on the upper surface; the sticker layers placed
and equally spaced apart on the lower surface of oilpaper, with a glossy side glued onto oilpaper by the adhesive points or layers of lower viscosity; the adhesive layer coated on the bottom side of the sticker layers with viscosity higher than that of the adhesive points or layers; to be adhered to a predetermined position, the sticker layer will be pressed to separate from the adhesive point of layer on the top side.

2. As mentioned in claim 1 of the sticker exclusive for the sticker machine, wherein the sticker being manufactured can be mounted with an additional layer of translucent film to the bottom side of the adhesive layer so as to increase the precise positioning of the sticker layers on oilpaper to prevent the adhesive side from clinging to the dust.
